(19) United States
(12) Patent Application Publication
(10) Pub. No.: US 2001/0048900 A1
(43) Pub. Date: Dec. 6, 2001

(54) Jet vortex mixer

(76) Inventors: Ronald L. Bardell, Redmond, WA (US); Gerald L. Klein, Edmonds, WA (US)

Correspondence Address: JERROLD J. LITZINGER, SENTRON MEDICAL, INC., 4445 LAKE FOREST DR., SUITE 600, CINCINNATI, OH, 45242, US

(21) Appl. No.: 09/864,046

(22) Filed: May 23, 2001

Related U.S. Application Data
(60) Provisional application No. 60/206,878, filed on May 24, 2000.

(51) Int. Cl. B01L 3/00

(52) U.S. Cl. 422/100; 422/102

(57) ABSTRACT

A device for mixing separate distinct fluids within a microfluidic device to form a substantially homogeneous flow stream. The device is generally circular-shaped and contains no moving parts, and is capable of mixing both serial and laminar flow streams.

### CROSS-REFERENCE TO RELATED APPLICATIONS

This patent application claims benefit from of U.S. Provisional Patent Application Serial No. 60/206,878, filed May 24, 2000, which application is incorporated herein in its entirety by reference.

### BACKGROUND OF THE INVENTION

1. Field of the Invention

This invention relates generally to microscale devices for performing analytical testing and, in particular, to a device and method for mixing fluids within cartridges containing microfluidic channels which carry flowing liquids.

2. Description of the Prior Art

Microfluidic devices have recently become popular for performing analytic testing. Using tools developed by the semiconductor industry to miniaturize electronics, it has become possible to fabricate intricate fluid systems which can be inexpensively mass produced. These techniques may be used to enable the development of miniaturized fluidic circuits as building blocks for an advancement in the fields of medical diagnostics and chemical analysis.

One aspect of microfluidics technology is based on the very special behavior of fluids when flowing in channels approximately the size of a human hair. This phenomenon, known as laminar flow, exhibits very different properties within a microscale channel than fluids flowing within the macro world of everyday experience. Due to the extremely small inertial forces in microscale structures, practically all flow in microfluidic channels is laminar. This allows the movement of different layers of fluid and particles next to each other in a channel without any mixing, except for diffusion.

The principle of laminar flow has been addressed in a number of patents which have recently issued in the field of microfluidics. U.S. Pat. No. 5,716,852 is directed to a device, known as a T-Sensor, having a laminar flow channel and two inlet stream means in fluid communication with the laminar flow channel which has a depth sufficiently small to allow particles from one stream to diffuse into the other stream. U.S. Pat. No. 5,932,100 is directed to a microfabricated extraction system for extracting desired particles from a sample stream. This device, known as an H-Filter, contains a laminar flow extraction channel and two inlet stream means connected to the extraction channel, with separate outlets at the exit of the extraction channel for a product stream containing the extracted particles and a by-product stream containing the remainder of the sample stream.

Microfluidic technology can be used to deliver a variety of in vitro diagnostic applications at the point of care, including blood cell counting and characterization, and calibration-free assays directly in whole blood. There are also other applications for this technology, including food safety, industrial process control, and environmental monitoring. The reduction in size and ease of use of these systems allows the devices to be deployed closer to the patient, where quick results facilitate better patient care management, thus lowering healthcare costs and minimizing inconvenience. In addition, this technology has potential applications in drug discovery, synthetic chemistry, and genetic research.

A sample microfluidic analysis instrument for performing analytical testing which uses a disposable fluidic analysis cartridge is disclosed in U.S. patent application Ser. No. 09/080,691, which was filed on May 18, 1998, the disclosure of which is incorporated herein by reference. This instrument includes a cartridge holder, a flow cytometric measuring apparatus positioned for optical coupling with a flow cytometric measuring region on the cartridge, and a second measuring apparatus positioned to be coupled with a second analysis region on the cartridge. The cartridge holder includes alignment markings to mate with cartridge alignment markings. It also includes pump mechanisms coupled with pump interfaces on the cartridges and valve mechanisms to couple with valve interfaces on the cartridge.

In this type of system, valve and pump mechanisms are external to the cartridge, with the cartridge including the valve and pump interfaces. Upon loading a cartridge into the apparatus, the valve and pump mechanisms engage the valve and pump interfaces. Thus, it is critical that the interfaces provide an efficient and precise coupling between the cartridge and the external mechanisms. In addition, it is imperative that these external devices provide for a smooth flow of the fluids into and out of the cartridge to ensure accurate measurements within a microfluidic analysis system.

There are instances when an analysis of fluids within a microfluidic channel requires a mixture of two or more fluids. However, this can often be difficult due to the laminar flow properties of microfluidic channels. Therefore, it is desirable to have a device and method for mixing several fluids which is accessible within a microfluidic cartridge.

In macroscopic devices, mixing is generally accomplished using turbulence, three-dimensional flow structures, or mechanical actuators. Turbulence occurs in flows characterized by high Reynolds numbers, generally over 2,000. And while three-dimensional structures and mechanical actuators can effectively mix fluids where dimensions and space are not limiting design factors, the size and proportions of microscale devices make it difficult to employ these techniques for mixing fluids within these channels.

Several devices have been developed recently which attempt to improve fluid mixing within microscale devices. U.S. Pat. No. 5,921,678, which issued on Jul. 13, 1999 and is assigned to California Institute of Technology, describes the fabrication of a micro-electromechanical system sub-millisecond liquid mixer. This mixer operated at a high Reynolds number, between 2,000 and 6,000, to provide greater turbulence, which increase reactant area and reduced reaction times. In one embodiment, the mixer chip has two tee-shaped mixers connected by a channel which serves as a reaction chamber. Two opposing liquid streams are injected into the mixer chip. Each tee mixer has opposing channels where liquids meet head-on and exit into a third channel forming the base of the “T”.

U.S. Pat. No. 6,065,864, which issued on May 23, 2000 and is assigned to the Regents of the University of California, describes a micromechanical system which mixes a fluid using predominantly planar laminar flow. This system included a mixing chamber and a set of valves to establish the planar laminar flow in the mixing chamber. The device employs chaotic advections to mix fluids in a planar laminar environment. A chaotic flow field is one in which the path and final position of particles place within the field are highly sensitive to their initial position. In a chaotic flow field, particles initially done together may become widely separated, and the flow as a whole becomes well mixed. Chaotic advection is the process of mixing with flow fields that are regular in space and time, yet which cause particles initially close together to become widely separated, and the flow as whole to become well mixed.

U.S. Pat. No. 6,136,272, which issued on Oct. 24, 2000, and is assigned to the University of Washington, teaches a device for rapidly joining and splitting fluid layers within microfluidic channels which allows for diffusional mixing in two directions, in the depth direction and in the width direction. This device provides for some diffusional mixing between laminar fluid layers.

### SUMMARY OF THE INVENTION

It is therefore an object of the present invention to provide a microfluidic device having the capability of thoroughly mixing different fluids to form a substantially homogenous flow stream.

It is a further object of the present invention to provide a mixing element for a microscale device having no moving parts.

It is a still further object of the present invention to provide a device which is capable of mixing both laminar and serial flow streams.

It is a still further object of the present invention to provide a mixing device within a microfluidic circuit which is simpler, inexpensive and easily operated.

These and other objects and advantages of the present invention will be readily apparent in the description that follows.

### BRIEF DESCRIPTION OF THE DRAWINGS

FIG. 1 is an illustration of the fluid flow through the microfluidic flow channel of a T-sensor, exhibiting laminar flow in the device;

FIG. 2 is an illustration of an alternate fluid flow through a microfluidic channel, which exhibits flow of discrete material regions;

FIG. 3 is a plan view of an oscillating vortex mixer according to the present invention;

FIG. 4 is a view of the mixer of FIG. 3, illustrating the flow pattern of the vortex developed within the mixer in the forward direction;

FIG. 5 is a view of the mixer of FIG. 3, illustrating the flow pattern of the vortex developed within the mixer in the reverse direction;

FIG. 6 is a cross-sectional view of the mixer of FIG. 3, illustrating the mixing effect of the mixer during operation;

FIG. 7 is a view of an alternative embodiment of a mixer according to the present invention;

FIG. 8 is a view of the mixer of FIG. 7, illustrating the flow pattern of the vortex developed within the mixer;

FIG. 9 is a cross-sectional view of the mixer of FIG. 7, illustrating the mixing effect of the mixer during operation;

FIG. 10 is a view of an alternative embodiment of the mixer of the present invention having multiple stages;

FIG. 11 is a figure displaying several different alternative configurations of the mixer of the present invention; and

FIG. 12 is a perspective view of another embodiment of the mixer of the present invention.

### DESCRIPTION OF THE PREFERRED EMBODIMENTS

Referring now to FIG. 1, there is shown a T-Sensor generally indicated at 10. The principles of operation of T-Sensor 10 are discussed in detail in U.S. Pat. No. 5,716,852, which patent is hereby incorporated by reference in its entirety. T-Sensor 10 consists of a sample stream inlet port 12, a sample stream channel 14, an indicator stream port 16, and an indicator stream channel 18. Sample stream channel 14 meets indicator stream channel 18 at T-joint 20 at the beginning of a flow channel 22. When a liquid sample is introduced into each of ports 12, 16, a pair of streams 24, 26 flow through channels 14, 18 and into flow channel 22. Streams 24, 26 move in parallel laminar flow within channel 22 due to the low Reynolds number in channel 22, as no turbulence mixing occurs. Flow channel 22 exits into an outlet port 28. Outlet port 28 can be coupled to a microfluidic system to supply two discrete fluids within a single stream.

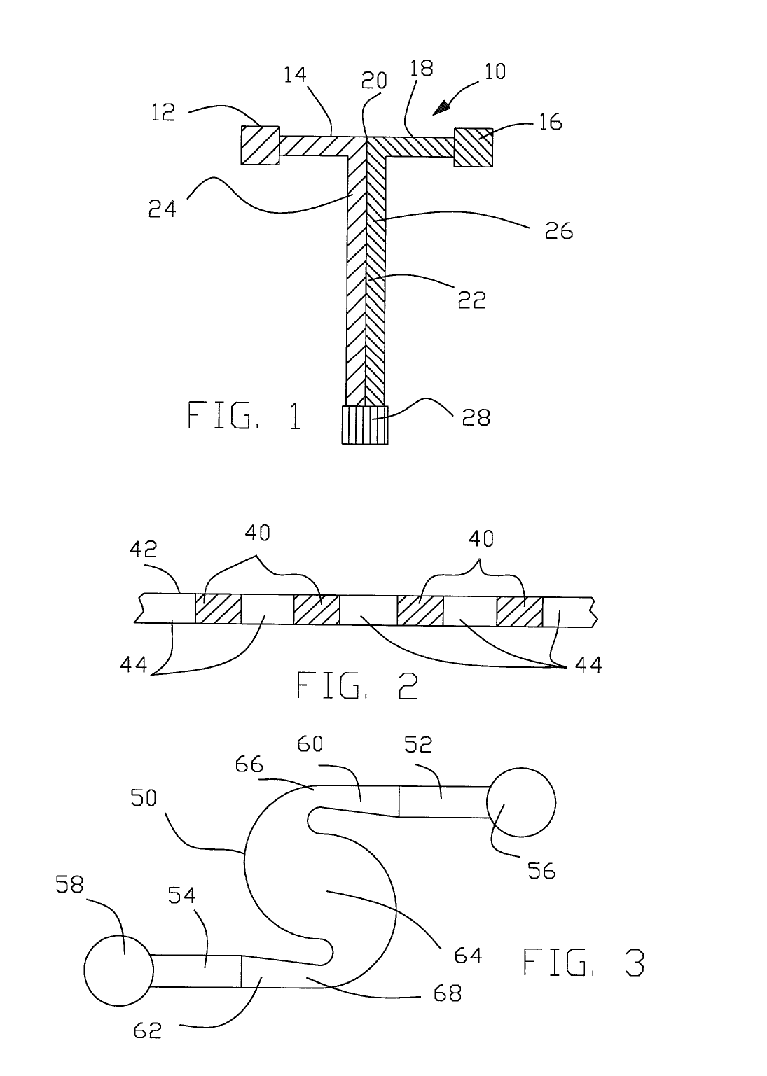

FIG. 2 illustrates another method by which two discrete fluids can be supplied to a microfluidic analysis system within a single stream. Referring now to FIG. 2, a series of discrete material regions 40, which represent sample plugs, species bands or the like, travel through a microfluidic channel 42 separated by a series of second material regions 44.

It is often desirable that discrete fluids be mixed to form a single homogeneous mixture for analysis in a microfluidic system. The ability to mix fluids thoroughly in a reasonable amount of time is fundamental to microfluidic analysis systems. Effective mixing of fluids requires that the fluids be manipulated such that the contact area between the fluids is increased. This is very difficult when dealing with microscale systems, as the physical devices employed are three-dimensional structures generally consisting of one of more extremely small dimensions. Microscale structures generally include one structural element having a dimension in the range of from about 0.1 μm to about 500 μm.

FIG. 3 is a plan view of a jet vortex mixer according to the present invention. A vortex mixing device 50 is connected to a first channel 52 and also a second channel 54. Channels 52, 54 are connected to a pair of pumping valves 56, 58 respectively at the ends opposite mixer 50.

Mixer 50 includes a pair at sections 60, 62 which connect to main central chamber 64 of mixing device 50 at its opposite ends. Sections 60, 62 are connected to mixer 50 such that each section is tangent to the outer boundary of mixing device 50. Each section 60, 62 is designed such that its cross-sectional area normal to the flow direction of a fluid entering or exiting mixer 50 is minimized in order to maximize the velocity of the fluid jet entering or exiting said section, as shown at 66, 68 respectively.

Mixing device 50 may consist of a planar structure with circular or oval boundaries, as shown in FIG. 3, or it may have other similar curved shapes having mathematically smooth perimeters. Mixer 50 is designed to allow fluid contained within the central portion 64 to rotate within mixer 50, creating turbulence by forming a vortex. Sections 66, 68 are oriented with respect to central portion 64 such that the momentum of fluids entering mixer 50 from channels 52, 54 will induce a common direction of rotation of fluid within central portion 64. The fluids to be mixed may be two or more clear fluids, solutions, particulate suspensions, colloidal fluids, or other liquids.

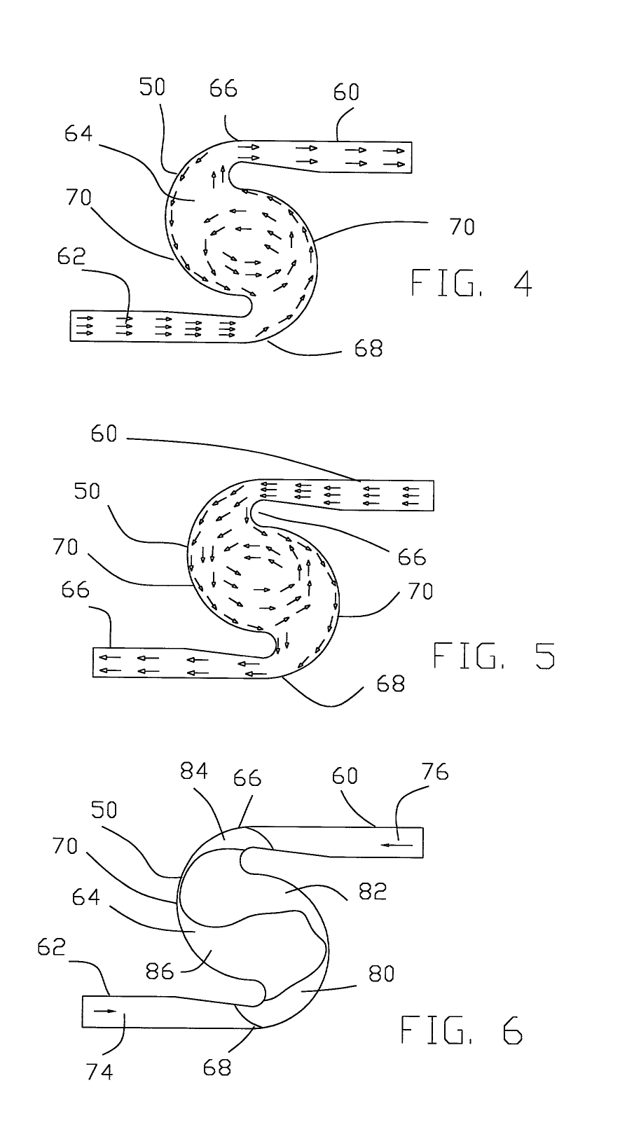

The operation of mixer 50 is shown in FIGS. 4-6. Referring now to FIG. 4, vortex mixer 50 has a fluid entering at section 62, flowing through narrowed section 68 and into central chamber 64. Fluid exits mixer 50 through narrowed section 66 and out through section 60. Mixer 50 serves to effectively mix separate fluids which enter the device through a single port, such as the parallel laminar streams shown in FIG. 1 or the discrete species bands in a single stream shown in FIG. 2. As the fluid stream enters mixer 50 via section 62 when it is directed in by pumping valve 58 (FIG. 3), the momentum of the fluid entering central chamber 64 as it passes through narrowed section 68 will induce a common direction of rotation, shown as counterclockwise in FIG. 4, of the fluid within chamber 68. The rotational shear field created by this motion induces mixing of the discrete fluids. The jet vortex effect is enhanced by the curved walls 70 of chamber 64. As the fluid fills mixer 50, a stream containing both fluids exits through portion 60 toward pumping valve 56 (FIG. 3). Once mixer 50 is filled with fluid, pumping valve 56 may be activated, subjecting the stream to a reversal in direction, as can be seen in FIG. 5. The flow stream now returning through section 66 into chamber 64 increases in velocity, increasing the rotational speed of the vortex spinning in the counterclockwise direction, thus creating a further mixing effect on the discrete fluids within mixer 50.

Mixer 50 may also be filled using several other methods. An alternate method of filling involves injecting separate unmixed fluids simultaneously in parallel into sections 60 and 62 in the correct proportions at a flow rate such that chamber 64 is completely filled and no significant pockets of gas remain trapped within chamber 64. Another alternative method involves filling chamber 64 through one of sections 60, 62 with a single fluid until chamber 64 is completely filled without any significant pockets of trapped gas. A second fluid is then injected into the same section at a slow enough rate that the second fluid does not induce a vortex in chamber 64, but rather forms a stream that passes through chamber 64. After chamber 64 has been filled, mixer 50 can be operated by activating pumping valve 56, as previously described.

FIG. 6 is a diagram showing the species concentration along the centerplane of mixer 50. A first fluid 74 representing 100% of initial concentration of a fluid enters mixer 50 via section 62, while a second fluid 76 representing 0% concentration of first fluid 74 enters at section 60. As fluids 74, 76 enter central chamber 64 of mixer 50, the tangential momentum forces each fluid against curved walls 70, creating a clockwise vortex motion. As fluid 74 passes through section 68 into chamber 64 the 100% concentration is reduced, as can be seen at 80 and 82. Similarly, as fluid 76 passes through section 66 into chamber 64, the 0% concentration increases as seen at 84 and 86. Eventually, as the mixture is cycled back and forth through mixer 50, a homogeneous solution, which is approximately 50% of fluid 74 and 50% of fluid 76, is formed.

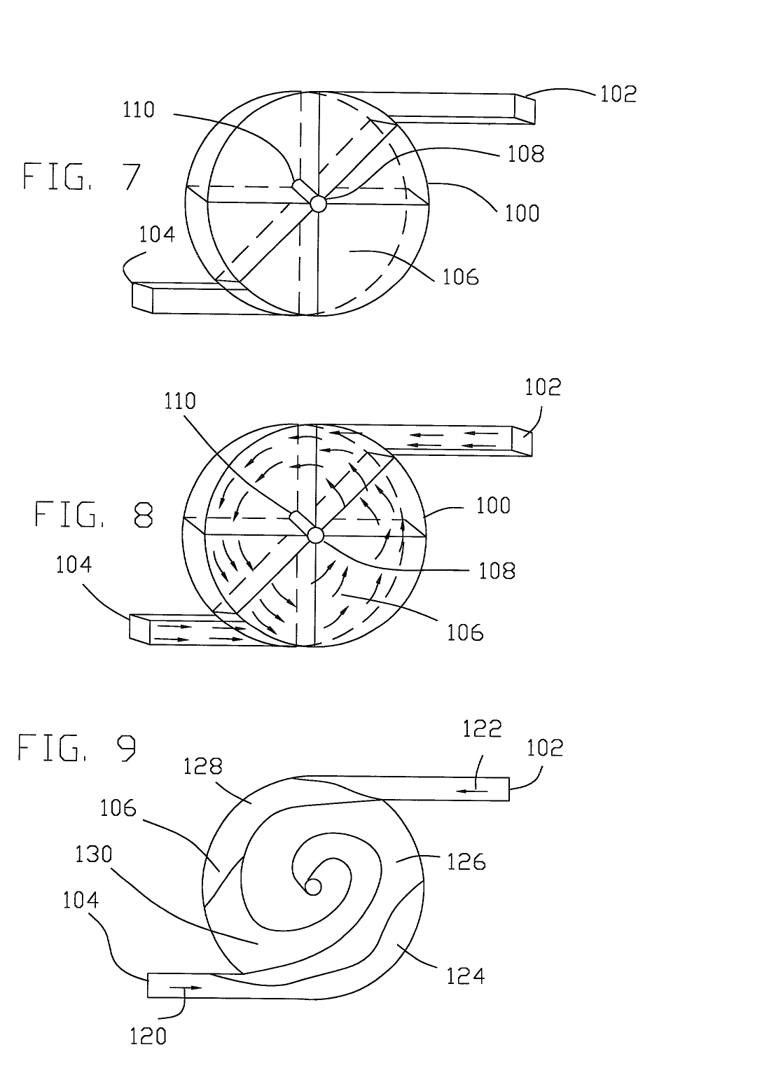

FIGS. 7-9 illustrate another embodiment of the vortex mixer of the present invention. This mixer is effective for mixing two discrete fluids from different sources. Referring now to FIG. 7, there is shown a vortex mixer 100 having a first inlet channel 102, and a second inlet channel 104. Inlet channels 102, 104 are tangential to the outer diameter of mixer 100. Mixer 100 is generally circular-shaped with an inner chamber 106, and is connected to the exterior of mixer 100 through a pair of outlet ports 108, 110 which are located on opposite sides of mixer 100.

In operation, a first fluid stream is delivered to mixer 100 at inlet channel 102, while a second fluid stream enters at inlet channel 104. As the fluid streams enter inner chamber 106 from tangential channels 102, 104, a vortex is created within chamber 106, as the tangential momentum of the moving fluids generates a counterclockwise rotation, acting to mix the fluids as chamber 106 fills. When the fluids reach the center of chamber 106, they are thoroughly mixed to a homogeneous solution, which solution exits mixer 100 via outlet ports 108, 100 on opposite sides of device 100. The flow pattern within mixer 100 is illustrated by the arrows shown in FIG. 8. The applied pressure difference between inlets 102, 104 and outlet ports 108, 110 is 0.5 atm, resulting in velocities of 500 mm/sec within chamber 106 and at least twice this velocity at port 108, 110. The highest Reynolds number is 320 at ports 108, 110.

FIG. 9 is a diagram showing the species concentration along the centerplane of mixer 100. A first fluid 120 representing 100% of initial concentration of first fluid 120 enters mixer 100 at inlet channel 104, while a second fluid 122 representing 0% concentration enters at inlet channel 102. As fluids 120, 122 enter central chamber 106, the tangential momentum forces each fluid against the inner wall of chamber 106, creating a clockwise vortex motion. As fluid 120 progresses toward outlet ports 108, 110 of mixer 100, the 100% concentration is reduced, as can be seen at 124 and 126. Similarly, as fluid 122 progresses toward the central portion of mixer 100, the 0% concentration increases as seen at 128 and 130. As the fluids reach outlet ports 108, 110, fluids 120, 122 are thoroughly mixed into a homogenous mixture.

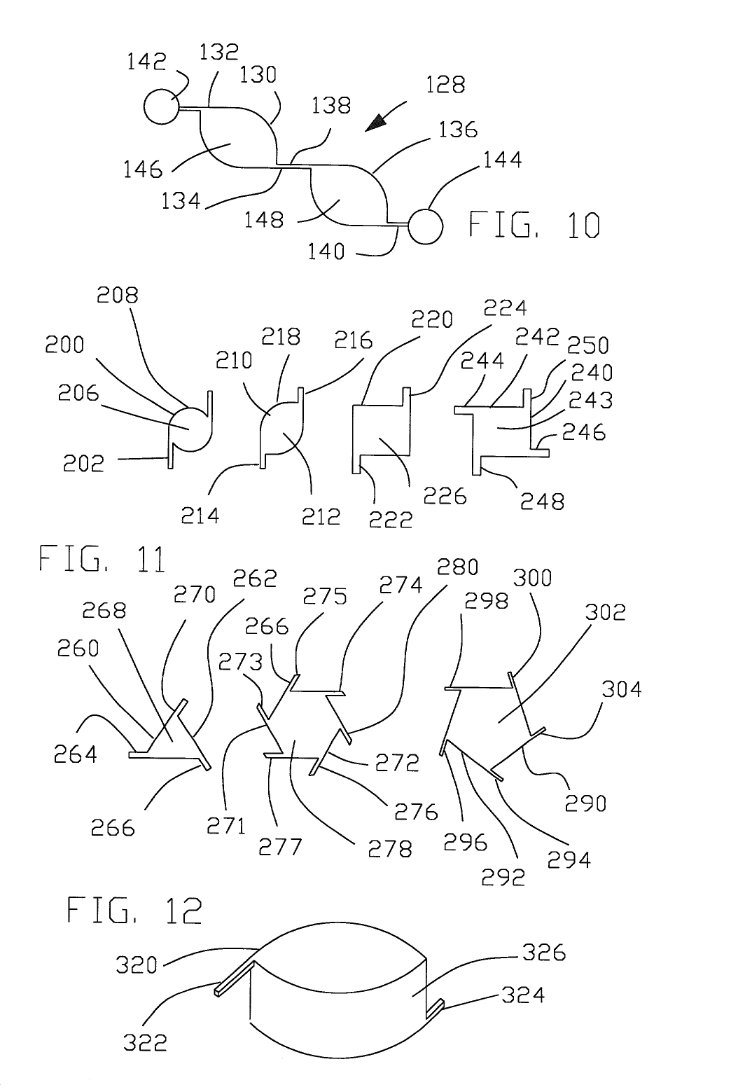

FIG. 10 illustrates an embodiment of the present invention in which several individual mixing devices are coupled together to increase the speed and mixing of separate fluids. A mixing device, generally indicated at 128, contains a first mixer 130 which has an inlet channel 132 and an outlet channel 134. Channel 134 is coupled to a second mixer 136 having an inlet channel 138 and an outlet channel 140 by directly coupling channels 134, 138 together. Inlet channel 132 is coupled to a pumping valve 142 while outlet channel 140 is coupled to a pumping valve 144. Each mixer 130, 136 contains a mixing chamber 146, 148 respectively. The operation of mixing device 128 is essentially identical to that of mixer 50 shown in FIG. 3, except that the fluids to be mixed flow through both mixing chambers 146, 148 before the desired pumping valve is activated to reverse the flow through mixer 128, thus providing a different mixing process than that of FIG. 3.

FIG. 11 illustrates a group of additional embodiments which employ the principles of the present invention. Referring now to FIG. 11, there is shown a mixing device 200, having a tangential input channel 202 and a tangential output channel 204. A mixing chamber 206 is circularly shaped such that channels 202, 204 meet chamber 206 as tangents to the circular perimeter 208 of chamber 206, similar to chamber 50 of FIG. 3. Mixing device 210, which contains a mixing chamber 212, is similar to mixer 200, having an input channel 214 and an output channel 216 tangential to chamber 212. Mixing chamber 212 contains an elliptically shaped perimeter 218, which causes a different vortex effect on the action of mixer 210.

A square-shaped mixing device 220 having an input channel 222 and an output channel 224 is also shown in FIG. 11. Mixer 220 contains a mixing chamber 226 which serves to create a vortex flow within chamber 226 when fluids are pulled into and out of mixer 220. All of the above mixers 200, 210, 220 may be used to mix two discrete fluids flowing into input channels 202, 214, 222 respectively into a single homogeneous fluid.

It is also possible to mix multiple discrete fluids entering from multiple inputs with devices similar to mixer 220. A multiple input mixing device 240 having a square perimeter shape 242 similar to that of mixer 220 and a mixing chamber 243 has a plurality of input channels 244, 246, 248 along with a single output channel 250. As fluids through channels 244, 246, 248 into chamber 243, a vortex is created, thus mixing the fluids such that a substantially homogeneous fluid exits mixer 240 at exit channel 250.

Other shapes can be employed for constructing mixing devices according to the present invention. A mixing device 260 having a triangular perimeter 262 is shown with a pair of separate input channels 264, 266 leading to a mixing chamber 268. A single exit channel 270 is disposed at one corner of perimeter 262. A mixing device 271 having a hexagonal perimeter 272 is shown with a plurality of inputs, 273, 274, 275, 276, 277, leading to a mixing chamber 278. A single exit channel 280 is disposed at one corner of perimeter 272. Finally, a mixing device 290 having a pentagonal perimeter 292 is shown with a plurality of inputs 294, 296, 298, 300 leading to a mixing chamber 302. A single exit channel 304 is disposed at one corner of perimeter 292.

All of the mixing devices shown in FIG. 11 operate in the same manner as mixer 50 of FIG. 3 in that as fluids move back and forth through the devices, laminar recirculation is created within the mixing chamber. All of these devices are considered two-dimensional devices, as the mixing action is only created within the depth of the microfluidic channels.

Often it is desirable within a multiple layer microfluidic analysis device, such as the device taught in U.S. patent application Ser. No. 09/080,691, which was discussed previously, to mix fluids which are located within different layers. FIG. 12 illustrates a device which employs the principles of the present invention to accomplish this type of mixing. Referring now to FIG. 12, there is shown a mixing device 320 having a first port channel 322 and second port channel 324. Mixer 320 contains a mixing chamber 326, which encompasses three dimensions in that channels 322, 324 are not located within the same plane. The operation of mixer 320 is identical to that of mixer 50 shown in FIG. 3. As fluid is pumped in and out of chamber 326, a three-dimensional vortex, similar to a tornado funnel, is generated within chamber 326, serving to thoroughly mix any discrete fluids which had been transmitted into mixer 320.

While the present invention has been shown and described in terms of several preferred embodiments thereof, it will be understood that this invention is not limited to these particular embodiments and that many changes and modifications may be made without departing from the true spirit and scope of the invention as defined in the appended claims.

What is claimed is:

1. A microfluidic device for mixing discrete fluids, comprising:
at least one fluid port;
a mixing chamber coupled to said first fluid port;
a first discrete fluid introduced into one of said fluid ports;
and a second discrete fluid introduced into one of said ports;
whereby said mixing chamber is shaped to create a vortex when said first and second fluids enter said chamber such that said first and second fluids are mixed into an essentially homogeneous mixture.

2. The device of claim 1, wherein said first and second fluids enter said mixing change in side-by-side relationship in a single stream.

3. The device of claim 1, wherein said first and second fluids enter said mixing device seriatim.

4. The device of claim 1, further comprising an exit port, coupled to said mixing chamber, for removing said homogeneous mixture from said chamber.

5. The device of claim 1, wherein the shape of said mixing chamber comprises a mathematically smooth perimeter.

6. The device of claim 1, wherein the shape of said mixing chamber is selected from the following: triangular, square, pentagonal, and hexagonal.

7. The device of claim 4, further comprising pump means coupled to one of said ports, capable of transferring fluids into and out of said mixing chamber.

8. The device of claim 1, wherein said first and second fluids have a Reynolds number between 1 and 2000.

9. A microfluidic device for mixing discrete fluids, comprising:
a first fluid port for introduction of a first discrete fluid;
a second fluid port for introduction of a second discrete fluid;
and a mixing chamber coupled between said first and second ports,
whereby said mixing chamber is so shaped as to create a vortex when said first and second fluids are introduced into said mixing chamber such that said first and second fluids are mixed into an essentially homogeneous mixture.

10. The device of claim 9, further comprising a third fluid port coupled to said mixing chamber for removing the essentially homogeneous mixture from said chamber.

11. The device of claim 9, wherein use of said ports includes pump means coupled to said mixing chamber for transferring fluids into and out of said mixing chamber to further enhance mixing.

12. The device of claim 9, wherein said first fluid port and said second fluid port are located in the same plane.

13. The device of claim 9, wherein said first fluid port and said second fluid port are located in different planes.

14. The device of claim 12, wherein said third fluid port is oriented in a plane perpendicular to said first and second ports.

15. The device of claim 10, further comprising a second mixing chamber, coupled to said third fluid port and so shaped to create a vortex when fluids are introduced, to further enhance the mixing of said first and second fluids.

16. The device of claim 9, wherein said first and second fluids each have a Reynolds number between 1 and 2000.

17. A microfluidic device for mixing discrete fluids, comprising:
a first fluid port for introduction of a first discrete fluid;
a second fluid port for introduction of a second discrete fluid;
and a mixing chamber coupled between said first and second ports,
whereby said mixing chamber is so shaped as to cause turbulence within said chamber when said first and second fluids are introduced such that said first and second fluids are mixed into an essentially homogeneous mixture.
